(19) United States
(12) Patent Application Publication
(10) Pub. No.: US 2024/0200438 A1
(43) Pub. Date: Jun. 20, 2024

(54) REAL-TIME DRILLING PARAMETER ADHERENCE

(71) Applicant: Schlumberger Technology Corporation, Sugar Land, TX (US)

(72) Inventors: Xia Guo, Beijing (CN); Bo Bi, Beijing (CN); Florian Le Blay, Clamart (FR); Chang Liu, Beijing (CN); Kewen Sun, Beijing (CN)

(21) Appl. No.: 18/528,832

(22) Filed: Dec. 5, 2023

Related U.S. Application Data
(60) Provisional application No. 63/387,549, filed on Dec. 15, 2022.

(51) Int. Cl. E21B 45/00; E21B 21/08; G08B 21/18

(52) U.S. Cl. CPC E21B 45/00; E21B 21/08; G08B 21/182

(57) ABSTRACT

A method for monitoring an adherence of actual drilling parameters to planned drilling parameters in real-time includes receiving a well plan for a well. The well plan includes a plurality of planned drilling parameters corresponding to a plurality of intervals in the well. The method also includes receiving actual drilling parameters corresponding to the plurality of intervals in the well and comparing the actual drilling parameters to the planned drilling parameters. The method also includes determining a plurality of compliance indicators based at least partially upon the comparison. The compliance indicators indicate a level of adherence between the actual drilling parameters adhere to the planned drilling parameters. The method also includes generating a first alarm in response to greater than a first predetermined amount and less than a second predetermined amount of the compliance indicators being below a planned minimum threshold, above a planned maximum threshold, or both.

### CROSS-REFERENCE TO RELATED APPLICATIONS

This application claims priority to U.S. Provisional Patent Application No. 63/387,549, filed on Dec. 15, 2022, which is incorporated by reference.

### BACKGROUND

Conventional systems and methods provide a table-style dashboard to compare real-time drilling parameters versus a planned operation window. The conventional dashboard shows compliance with colored (e.g., red, yellow, and/or green) blocks. However, the conventional dashboard does not determine flowrate compliance during a drilling operation. Moreover, when viewing the conventional dashboard, it is difficult to understand whether the noncompliance is caused by a change to the planned window or by a real-time drilling data change. Furthermore, the conventional dashboard does not provide a summarized (e.g., overall) run or well compliance score. As such, it is difficult to compare run-to-run or well-to-well in terms of drilling parameters compliance. In addition, the conventional dashboard should be open to provide the compliance status.

### SUMMARY

A method for monitoring an adherence of actual drilling parameters to planned drilling parameters in real-time is disclosed. The method includes receiving a well plan for a well. The well plan includes a plurality of planned drilling parameters corresponding to a plurality of intervals in the well. The method also includes receiving actual drilling parameters corresponding to the plurality of intervals in the well. The method also includes comparing the actual drilling parameters to the planned drilling parameters. The method also includes determining a plurality of compliance indicators based at least partially upon the comparison. The compliance indicators indicate a level of adherence between the actual drilling parameters adhere to the planned drilling parameters. The method also includes generating a first alarm in response to greater than a first predetermined amount and less than a second predetermined amount of the compliance indicators being below a planned minimum threshold, above a planned maximum threshold, or both.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving a well plan for a well. The well plan includes a plurality of planned drilling parameters corresponding to a plurality of intervals in the well. The intervals include depth intervals or time intervals. The planned drilling parameters each include a minimum value, a maximum value, and a recommended value. The planned drilling parameters include a planned depth of the well, a planned rate of rotation of a tubular string in the well, a planned weight on a drill bit in the well, a planned flow rate of a fluid into or out of the well, a planned rate of penetration in the well, or a combination thereof. The operations also include receiving actual drilling parameters corresponding to the plurality of intervals in the well. The actual drilling parameters include a measured depth of the well, a measured rate of rotation of the tubular string in the well, a measured weight on the drill bit in the well, a measured flow rate of the fluid into or out of the well, a measured rate of penetration in the well, or a combination thereof. The operations also include comparing the actual drilling parameters to the planned drilling parameters. The operations also include determining a plurality of compliance indicators based at least partially upon the comparison. The compliance indicators indicate a level of adherence between the actual drilling parameters adhere to the planned drilling parameters. A first of the compliance indicators includes a plurality of first values representing differences between a first of the actual drilling parameters and a first of the planned drilling parameters at each of the intervals in the well. A second of the compliance indicators includes a plurality of second values representing differences between a second of the actual drilling parameters and a second of the planned drilling parameters at each of the intervals in the well. The operations also include generating a first alarm in response to greater than a first predetermined amount and less than a second predetermined amount of the first values being below a planned minimum threshold, above a planned maximum threshold, or both. The operations also include generating a second alarm in response to greater than the second predetermined amount of the first values being below the planned minimum threshold, above the planned maximum threshold, or both. The operations also include generating a third alarm in response to greater than the first predetermined amount and less than the second predetermined amount of the first values being below the planned minimum threshold, and greater than the first predetermined amount and less than the second predetermined amount of the first values being above the planned maximum threshold. The operations also include generating a display based upon the comparison, the compliance indicators, the first alarm, the second alarm, the third alarm, or a combination thereof.

A non-transitory computer-readable medium is also disclosed. The medium stores instructions that, when executed by at least one processor of a computing system, cause the computing system to perform operations. The operations include receiving a well plan for a well. The well plan includes a plurality of planned drilling parameters corresponding to a plurality of intervals in the well. The intervals include depth intervals or time intervals. The planned drilling parameters each include a minimum value, a maximum value, and a recommended value. The planned drilling parameters include a planned depth of the well, a planned rate of rotation of a tubular string in the well, a planned weight on a drill bit in the well, a planned flow rate of a fluid into or out of the well, and a planned rate of penetration in the well. The operations also include receiving actual drilling parameters corresponding to the plurality of intervals in the well. The actual drilling parameters are received substantially in real-time. The actual drilling parameters include a measured depth of the well, a measured rate of rotation of the tubular string in the well, a measured weight on the drill bit in the well, a measured flow rate of the fluid into or out of the well, and a measured rate of penetration in the well. The operations also include determining a statistical distribution of the actual drilling parameters. The statistical distribution is based at least partially upon the well plan. The statistical distribution is determined by percentiles and summarized at each of the intervals. The operations also include comparing the actual drilling parameters to the planned drilling parameters. The comparison includes comparing the statistical distribution of the actual drilling parameters to the planned drilling parameters. The operations also include determining a plurality of compliance indicators based at least partially upon the comparison. The compliance indicators indicate a level of adherence between the actual drilling parameters adhere to the planned drilling parameters. A first of the compliance indicators includes a plurality of first values representing differences between a first of the actual drilling parameters and a first of the planned drilling parameters at each of the intervals in the well. A second of the compliance indicators includes a plurality of second values representing differences between a second of the actual drilling parameters and a second of the planned drilling parameters at each of the intervals in the well. The plurality of compliance indicators further include an aggregate compliance indicator based upon the first and second compliance indicators. The operations also include generating a first alarm in response to greater than a first predetermined amount and less than a second predetermined amount of the first values and the second values being below a planned minimum threshold, above a planned maximum threshold, or both. The planned minimum threshold is different at two or more of the intervals. The planned maximum is different at two or more of the intervals. The operations also include generating a second alarm in response to greater than the second predetermined amount of the first values and the second values being below the planned minimum threshold, above the planned maximum threshold, or both. The operations also include generating a third alarm in response to greater than the first predetermined amount and less than the second predetermined amount of the first values and the second values being below the planned minimum threshold, and greater than the first predetermined amount and less than the second predetermined amount of the first values and the second values being above the planned maximum threshold. The operations also include generating a display based upon the comparison, the compliance indicators, the first alarm, the second alarm, the third alarm, or a combination thereof. The operations also include generating or transmitting a signal in response to the comparison, the compliance indicators, the first alarm, the second alarm, the third alarm or a combination thereof.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a schematic view of a workflow of drilling parameter adherence, according to an embodiment.

FIG. 3 illustrates a flowchart of a method for determining the adherence of actual drilling parameters to planned drilling parameters in real-time, according to an embodiment.

FIG. 4 illustrates a schematic view of a plurality of planned drilling parameters, according to an embodiment.

FIG. 5 illustrates a schematic view of a well provision, according to an embodiment.

FIG. 6 illustrates a schematic view of notification and/or alarm generation logic, according to an embodiment.

FIG. 7 illustrates a schematic view of a display, according to an embodiment.

FIG. 8 illustrates an example of a computing system for performing at least a portion of one or more of the methods described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

The present disclosure may use a simulator (e.g., Intersect) to compute a loss function while training a Physics-informed machine learning (PIML) model. This allows the loss function to be determined accurately by using a physical implementation available within a numerical simulator. The present disclosure also includes a framework based on a communication protocol that allows neural networks to call relevant computes from within the simulator to train a machine learning model. This ensures that the trained model incorporates the physics as well as any coupled information from within the simulator. No automatic differentiation or numerical computation of derivatives is involved. The nonlinearity and heterogeneity is resolved within the numerical simulator. This also allows a machine learning engineer to focus on creating the PIML model rather than having to describe and code the relevant physics for certain practical applications.

Thus, the present disclosure provides a new method/workflow of training PIML models on discrete nonlinear partial differential equations. The neural network uses a communication protocol to compute the loss function using a numerical simulator (e.g., Intersect). The derivatives and discrete variable coefficients may be computed within the simulator using a full physics full fidelity scheme. The ML model learns the exact physics and chemistry that is implemented in the simulator including complicated boundary conditions that are difficult to code in conventional workflows. The workflows may be supervised and/or unsupervised.

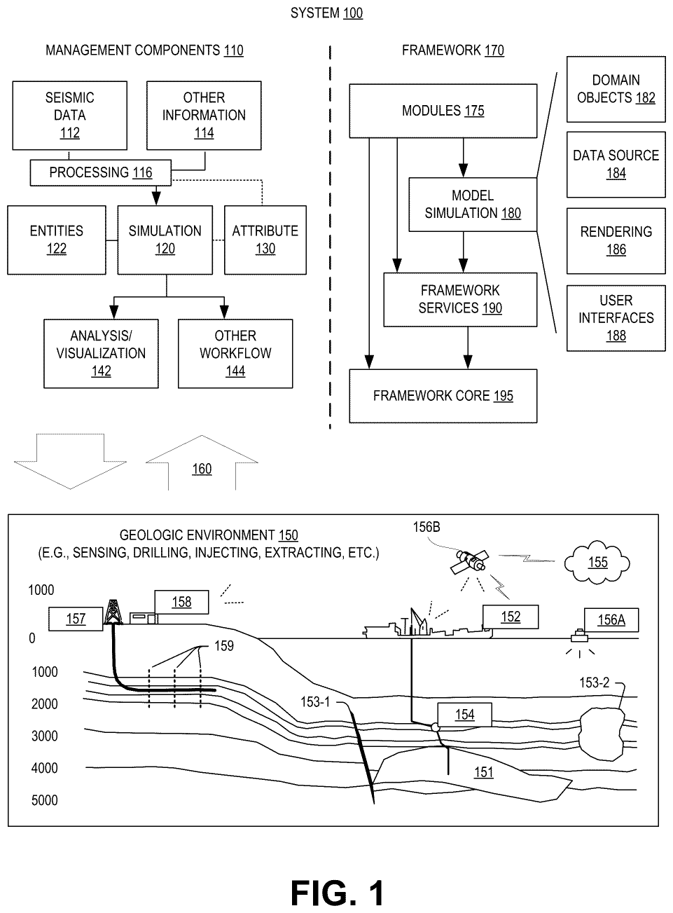

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 may include virtual representations of actual physical entities that are reconstructed for purposes of simulation. The entities 122 may include entities based on data acquired via sensing, observation, etc. (e.g., the seismic data component 112 and the additional information component 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes may be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that may output information for use in increasing reservoir performance, for example, by improving asset team productivity. Through use of such a framework, various professionals (e.g., geophysicists, geologists, and reservoir engineers) may develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered as a data-driven application. The PETREL® software may include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications may display their data while the user interfaces 188 may provide a common look and feel for application user interface components.

As an example, the domain objects 182 may include entity objects, property objects and optionally other objects. Entity objects may be used to geometrically represent wells, surfaces, bodies, reservoirs, etc., while property objects may be used to provide property values as well as data versions and display parameters. For example, an entity object may represent a well whereas a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project may be accessed and restored using the model simulation layer 180, which may recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a workstep may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Real-Time Drilling Parameter Adherence

In the planning phase of a well to be drilled, a drilling engineering team may consolidate the analyses from offset wells, the field block to design trajectory, the bottom hole assembly (BHA), the casing, the drilling parameters, or a combination thereof. In addition to the overall design, and also considering the actual rig deployment, an operating window may be defined so that, for each drilling run, the drilling parameters may be stored and/or regulated within predetermined ranges. The drilling parameters may be stored in a computer program (e.g., DrillPlan®). Illustrative drilling parameters may include the depth of the well, the surface rotations-per-minute (RPM) of a tubular (e.g., drill string) extending into the well, the surface weight-on-bit (WOB), the flow rate of a fluid into and/or out of the well, the rate of penetration (ROP) in the well, or a combination thereof. Each drilling parameter may have a minimum value, a maximum value, a recommended value, or a combination thereof.

The system and method described herein may automatically determine one or more planned drilling parameters of a well that is provisioned (e.g., from DrillPlan®). The system and method may also monitor and/or display how well actual drilling parameters follow the planned drilling parameters (e.g., within a window). As used herein, a “planned drilling parameter” refers to a drilling parameter that is selected by a user and/or determined before the well is drilled. As used herein, an “actual drilling parameter” refers to a drilling parameter that is measured during or after drilling (e.g., by surface equipment and/or the BHA in the well). The planned drilling parameters may be selected and/or determined before the actual drilling parameters are measured. The system and method may also raise a notification (e.g., alarm) when one or more of the actual drilling parameters deviate from the planned drilling parameters by greater than a predetermined threshold.

The system and method (e.g., DrillOps Advise) may provide predictive analytics. The predictive analytics may be a cloud-based application for real-time drilling interpretation. In an example, the predictive analytics may provide a compliance check for flowrate into and/or out of the well. The predictive analytics may be based upon real-time channels and context data from the (e.g., DrillOps) rig infrastructure and/or a third party (e.g., WITSML) server.

The system and method may receive a plurality of inputs. The inputs may include one or more planned drilling parameters. The planned drilling parameters may be in a planned BHA run and/or defined as a WISTML object. This identifies where the planned drilling parameters are located. For example, when the well is created (e.g., through DrillPlan), the planned drilling parameters may be contained inside of planned BHA run. It is also possible this data is streamed in through a WITSML server. These are two different ways to get the planned drilling parameters.

The inputs may also include bit depth (i.e., the depth of the drill bit in the well). The inputs may also include hole depth (i.e., the depth of the well). The inputs may also include hookload (e.g., to help determine rig activity). The inputs may also include block position (e.g., to help determine rig activity). The inputs may also include surface torque (e.g., to help determine rig activity). The inputs may also include surface weight-on-bit (WOB). The inputs may also include surface rotations-per-minute (i.e., the RPM of the drill string measured at the surface). The inputs may also include flow rate of the fluid flowing into and/or out of the well. The inputs may also include rate of penetration (ROP) in the well.

The system and method may determine and/or generate one or more outputs based upon the inputs. The outputs may include statistics for the (e.g., planned and/or actual) drilling parameters in predetermined time intervals (e.g., 10-minutes) and/or depth intervals (e.g., 10-meters). The outputs may also include a first (e.g., medium) alarm or a second (e.g., high) alarm depending on the severity of deviation of the actual drilling parameters from the planned drilling parameters. The outputs may also include one or more adherence indicators for a run or for a well considering the adherence for the parameters. The outputs may also include a display (e.g., a graphical representation) of the limits set in a digital drilling program (DDP) with the planned and/or actual drilling parameters plotted in real-time.

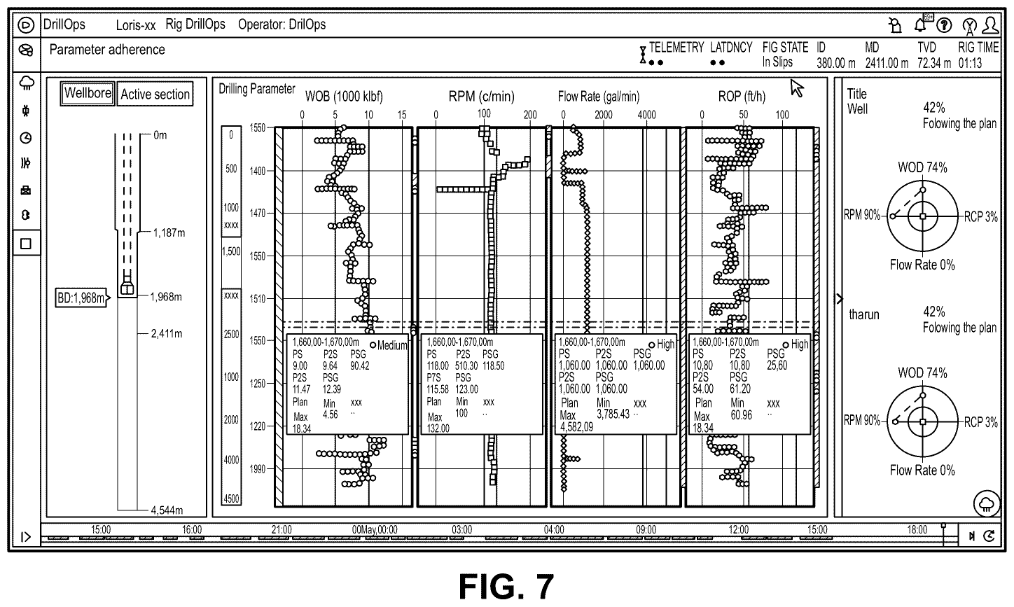

The system and method described herein may provide one or more features that are not provided using conventional techniques. For example, the system and method described herein may determine and/or generate the predictive analytics. In an example, the predictive analytics may provide a compliance check for flowrate into and/or out of the well. The system and method may also determine and/or generate a predictive analytics dashboard. The dashboard may provide a graphical view to show the WBG, lithology, and/or related planned operation window, together with real-time drilling parameter statistics. This layout makes it is easy for the user to see the changes to the drill plan and/or operation. The system and method may also determine and/or generate predictive analytics that provide a well level and/or run level summarized compliance score. An example of a compliance score (e.g., a percentage) is shown in the right side of FIG. 7. This may allow the user to compare different wells and/or different runs. The system and method may also provide predictive analytics that provide a notification and/or alarm to warn the user when the compliance score is not met. Thus, the user may be notified even when the dashboard is not open (i.e., when the program is closed/not running).

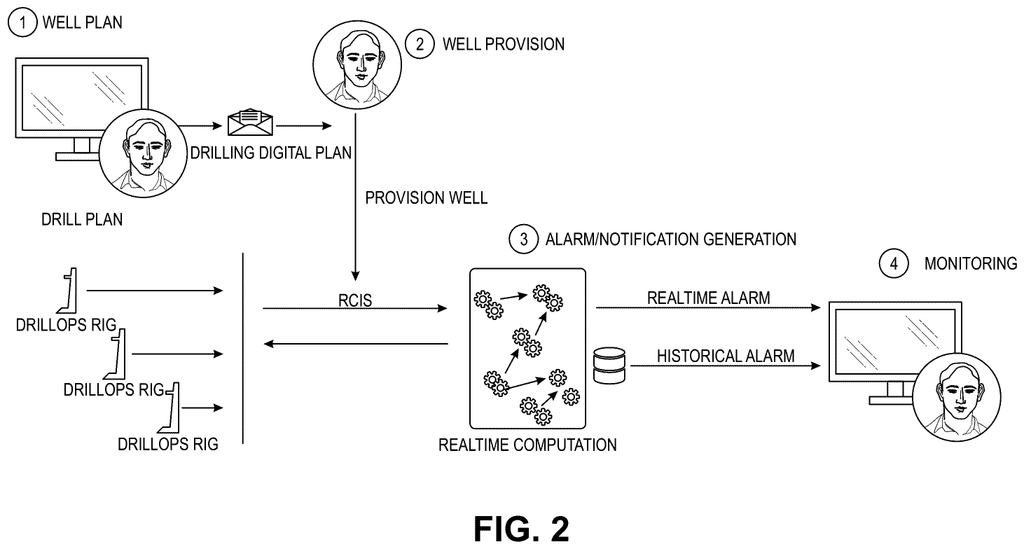

FIG. 2 illustrates a schematic view of a workflow for parameter adherence, according to an embodiment. As shown, a well plan may be received or determined. The well plan may be or include a drill plan (e.g., a drilling digital plan). Next, a well provision may be received or determined. The well provision may be based at least partially upon the well plan. For example, the well provision may be or include a well, a rig, planned drilling parameters, lithology, run information, etc. A notification (e.g., alarm) may be generated based at least partially upon the well provision, actual (e.g., measured) drilling parameters, or both. The alarm may be or include a real-time alarm, a historical alarm, or both. The real-time alarm may be or include deviation of WOB, RPM, flowrate, and/or ROP, and the historical alarm may be or include deviation of WOB, RPM, flowrate, and/or ROP. One or both alarms may be based on real-time data points, which may allow the user to see what happened in the past and/or what is happening currently.

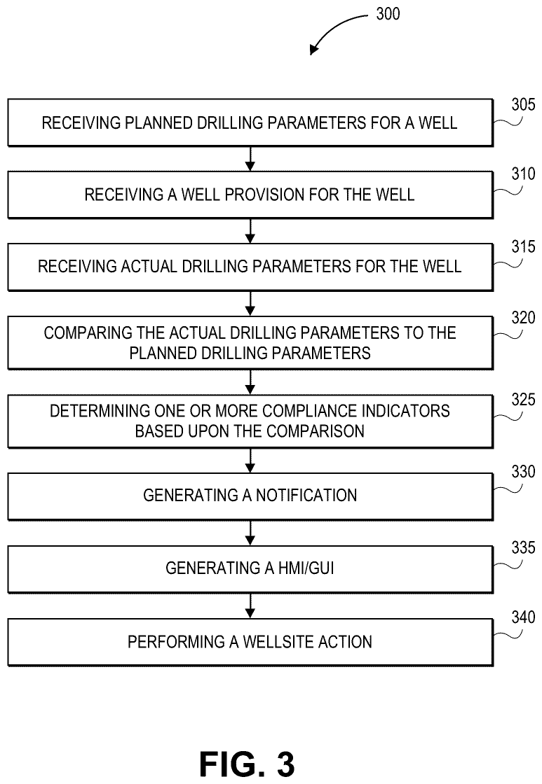

FIG. 3 illustrates a flowchart of a method 300 for determining or monitoring the adherence of the actual drilling parameters to the planned drilling parameters in real-time, according to an embodiment. The method 300 may be used to control the drilling of a well at a wellsite. The method 300 may be similar to the workflow shown in FIG. 2. An illustrative order of the method 300 is provided below; however, one or more portions of the method 300 may be performed in a different order, combined, repeated, or omitted.

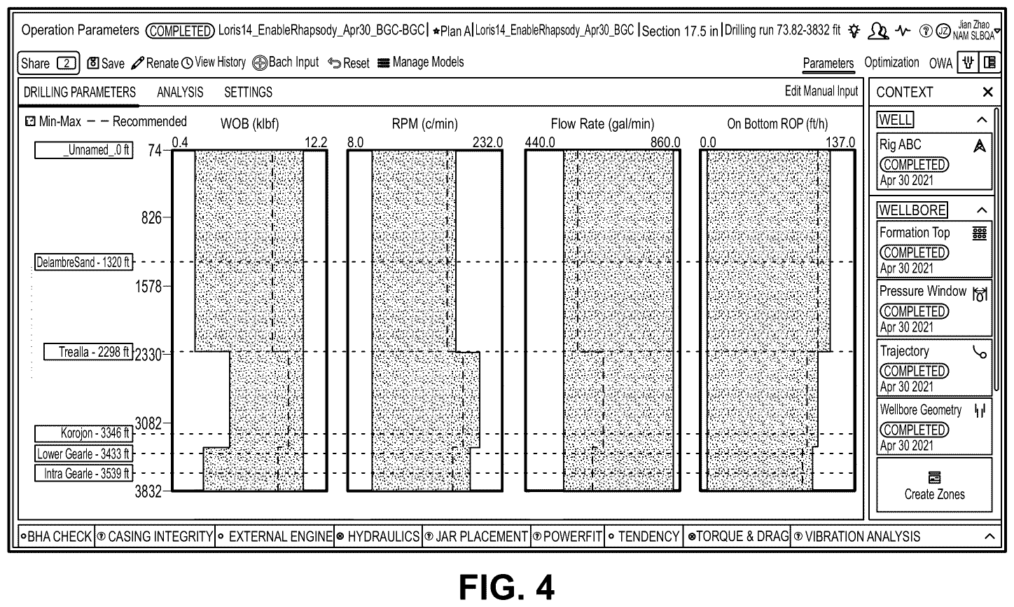

The method 300 may include receiving or determining a well plan for a well, as at 305. The well plan may include one or more planned drilling parameters for (e.g., drilling) a well. The planned drilling parameters may correspond to one or more (e.g., depth and/or time) intervals in the well. FIG. 4 illustrates a schematic view of one or more planned drilling parameters (e.g., in DrillPlan), according to an embodiment. In one embodiment, the planned drilling parameters may include or be positioned in a planned window. The planned window may be or include a depth-based and/or time-based window of the planned drilling parameters for the well.

As mentioned above, the planned drilling parameters may include the planned depth of the well, the planned surface RPM, the planned surface WOB, the planned flow rate, the planned ROP, or a combination thereof (e.g., in DrillPlan project). The planned drilling parameters may each include a minimum value, a maximum value, a recommended value, or a combination thereof. The planned drilling parameters (and their corresponding values) may be stored (e.g., in the DrillPlan project and/or encapsulated as the DDP). In one embodiment, the DDP may be used as a source for the planned drilling parameters in the implemented workflow. In another embodiment, the planned drilling parameters may be from any source and streamed into the system (e.g., with a BHA Run WITSML object).

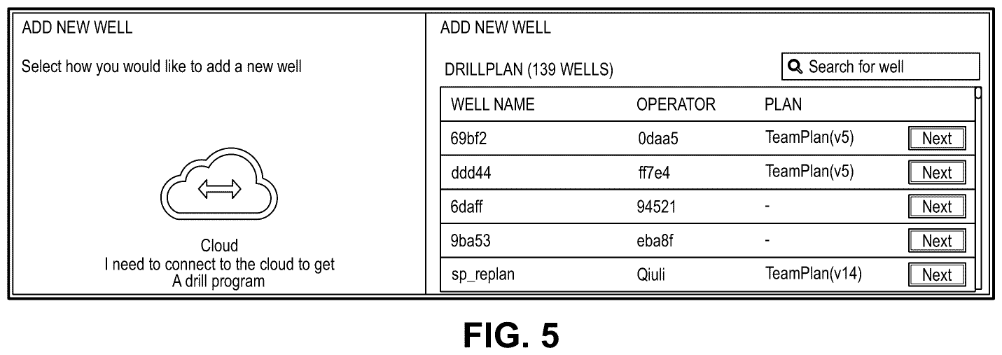

The method 300 may also include receiving or determining a well provision, as at 310. FIG. 5 illustrates a schematic view of a well provision (e.g., in DrillPlan), according to an embodiment. The well provision may be based at least partially upon the well plan. The well provision may include a well (e.g., from ‘Cloud’ in LandingPortal). The well may be a simulated well or an actual well. The well provision may also or instead a DDP name for (or based upon) the well. The planned drilling parameters may be extracted and/or distributed to the real-time computation.

The method 300 may also include measuring or receiving actual drilling parameters, as at 315. The actual drilling parameters may be measured and/or received at the plurality of (e.g., depth and/or time) intervals in the well. The actual drilling parameters may be received substantially in real-time (e.g., within 1 minute or less from being measured). In one embodiment, an online statistics technique may be performed on the actual drilling parameters to obtain or extract the data from the actual drilling parameters within a particular depth interval (e.g., a drilling stand). The actual drilling parameters may be or may include a measured depth of the well, a measured surface RPM, a measured surface WOB, a measured flow rate, a measured ROP, or a combination thereof. The actual drilling parameters may be measured by one or more sensors at the surface or in the well (e.g., in/on the BHA).

In one embodiment, measuring or receiving the actual drilling parameters may include determining a statistical distribution of the actual drilling parameters. The statistical distribution may be based at least partially upon the well plan (e.g., the planned drilling parameters), the well provision, streamed channel data (e.g., from the BHA in the well), or a combination thereof. The statistical distribution of the actual drilling parameters may be determined by percentiles (e.g., P5, P25, P50, P75, P95). The statistical distribution (e.g., the percentiles) may be summarized at predetermined time and/or depth intervals with the well and then output in real-time.

The method 300 may also include comparing the actual drilling parameters to the planned drilling parameters, as at 320. More particularly, this may include comparing the actual drilling parameters to the planned window (e.g., the depth-based window of the planned drilling parameters for the well).

The method 300 may also include determining one or more compliance indicators, as at 325. The compliance indicators may be determined based upon the comparison. The compliance indicators may be determined for a current BHA run and/or the whole well. The compliance indicators may be or may include one or more values that indicate how well the actual drilling parameters adheres to the planned drilling parameters in run and/or well scope. More particularly, the number of depth (or time) intervals with different statuses may be determined, and the value equals the ratio of the number of intervals with a normal status (e.g., within upper and lower thresholds) to the number of intervals with a known status (e.g., normal status+abnormal status). The compliance indicators may be determined for each specific parameter (e.g., surface WOB, surface RPM, ROP, and/or flow rate). In one embodiment, an overall compliance indicator may be determined based upon one or more of the individual compliance indicator values.

In an example, a first of the compliance indicators may be or may include one or more first values representing differences between a first of the actual drilling parameters and a first of the planned drilling parameters at one or more of the intervals in the well, and a second of the compliance indicators may be or may include one or more second values representing differences between a second of the actual drilling parameters and a second of the planned drilling parameters at one or more of the intervals in the well. The compliance indicators may also or instead include an aggregate compliance indicator based upon the first and second compliance indicators.

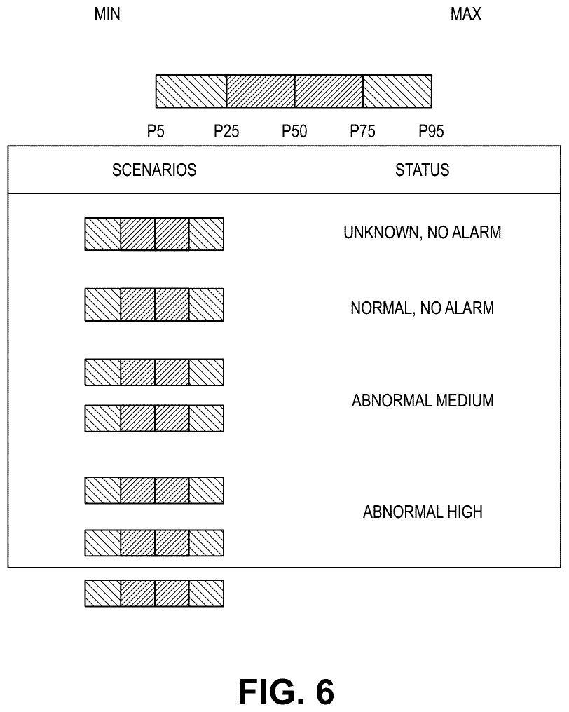

The method 300 may also include generating a notification (e.g., an alarm), as at 330. FIG. 6 illustrates a schematic view of notification and/or alarm generation logic, according to an embodiment. The notification and/or alarm may be based upon the comparison and/or the compliance indicators. For example, the notification and/or alarm may be based upon a comparison of the actual (e.g., measured drilling parameters) with the planned drilling parameters (e.g., the planned window). The notifications and/or alarms may be presented to attract the user's attention when a deviation is occurring.

In one embodiment, there may be no notification when there is no planned reference (i.e., no planned drilling parameters and/or planned window). There may also be no notification when less than a first (e.g., lower) predetermined amount (e.g., 10%) of the compliance indicators, the values, and/or the data associated therewith is below a planned minimum threshold or above a planned maximum threshold (e.g., for a particular drilling parameter). Here, the data may refer to the actual drilling parameters and/or the statistical distribution thereof. For each of the drilling parameters (or the compliance indicators and/or values associated therewith), the planned minimum threshold may be different at two or more of the depth intervals or time intervals, and the planned maximum may be different at two or more of the depth intervals or time intervals.

A first (e.g., medium) notification may be generated when greater than the first predetermined amount of the compliance indicators (e.g., values and/or data) and less than a second (e.g., higher) predetermined amount (e.g., 20%) of the compliance indicators (e.g., values and/or data) is below the planned minimum threshold or above the planned maximum threshold (e.g., for a particular drilling parameter). A second (e.g., high) notification may be generated when greater than the second predetermined amount (e.g., 20%) of the compliance indicators (e.g., values and/or data) is below the planned minimum threshold or above the planned maximum threshold (e.g., for a particular drilling parameter). A third notification may be generated when greater than the first predetermined amount (e.g., 10%) of the compliance indicators (e.g., values and/or data) and less than the second predetermined amount (e.g., 20%) of the compliance indicators (e.g., values and/or data) is below the minimum threshold, and greater than the first predetermined amount (e.g., 10%) of the compliance indicators (e.g., values and/or data) and less than the second predetermined amount (e.g., 20%) of the compliance indicators (e.g., values and/or data) is above the maximum threshold (e.g., for a particular drilling parameter).

The method 300 may also include generating a human machine interface (HMI) and/or graphical user interface (GUI), as at 335. In one embodiment, a display device may be controlled to present the HMI/GUI. The HMI/GUI may be based at least partially upon the well plan (e.g., the planned drilling parameters), the well provision, the actual drilling parameters (e.g., the statistical distribution), the comparison, the compliance indicators, the notification(s), or a combination thereof. The HMI/GUI may be or include one or more plots (e.g., graphs) that the user may monitor to visualize the actual drilling parameters together with the planned drilling parameters (e.g., the planned window).

For example, the HMI/GUI may include a plot showing the planned drilling parameters (e.g., planned window) versus the actual drilling parameters at one or more depth intervals and/or one or more time intervals. The actual drilling parameters may be shown as a bar with percentiles (e.g., P5, P25, P50, P75, P95). The HMI/GUI may also or instead show the WBG and/or lithology at the one or more depth intervals and/or the one or more time intervals. The HMI/GUI may also or instead show the notifications and/or alarms at the one or more depth intervals and/or the one or more time intervals.

FIG. 7 illustrates a schematic view of the HMI/GUI, according to an embodiment. Table 1 (below) shows an example the information shown in the display in FIG. 7.

TABLE 1

| Number | |
|---|---|
| position | Description |
| 1 | Wellbore geometry: plot of the current |
| | casing and/or bit depth. |
| 2 | Depth scale with zoom-in: select the |
| | depth interval to be visualized. |
| 3 | Lithology: lithology column from computer |
| | program (e.g., DrillPlan). |
| 4 | Planned operation window: planned min/max |
| | threshold for WOB, RPM, Flow rate, and/or ROP. |
| 5 | Actual drilling parameter statistics: |
| | output one statistical bar every 10 |
| | minutes of drilling and show percentile |
| | details in the tooltip. |
| 6 | Risk indicator and alarm: indicate the |
| | alarm status in depth index and time axis. |
| | A user may comment on an alarm by selecting |
| | it in time axis. |
| 7 | Parameter indicator: indicate how well the |
| | actual drilling parameter fits in the |
| | planned window in a run and/or across the well. |

The method 300 may also include performing a wellsite action, as at 340. The wellsite action may be performed based at least partially upon the well plan (e.g., the planned drilling parameters), the well provision, the actual drilling parameters (e.g., the statistical distribution), the comparison, the compliance indicators, the notification(s), or a combination thereof. The wellsite action may be or may include generating and/or transmitting a signal (e.g., using a computing system) that causes a physical action to occur at a wellsite. The wellsite action may also or instead include performing the physical action at the wellsite. The physical action may be or may include selecting where to drill a well, drilling the well, varying a weight and/or torque on a drill bit drilling the well, varying a drilling trajectory of the well, varying a concentration and/or flow rate of a fluid pumped into the well, or the like.

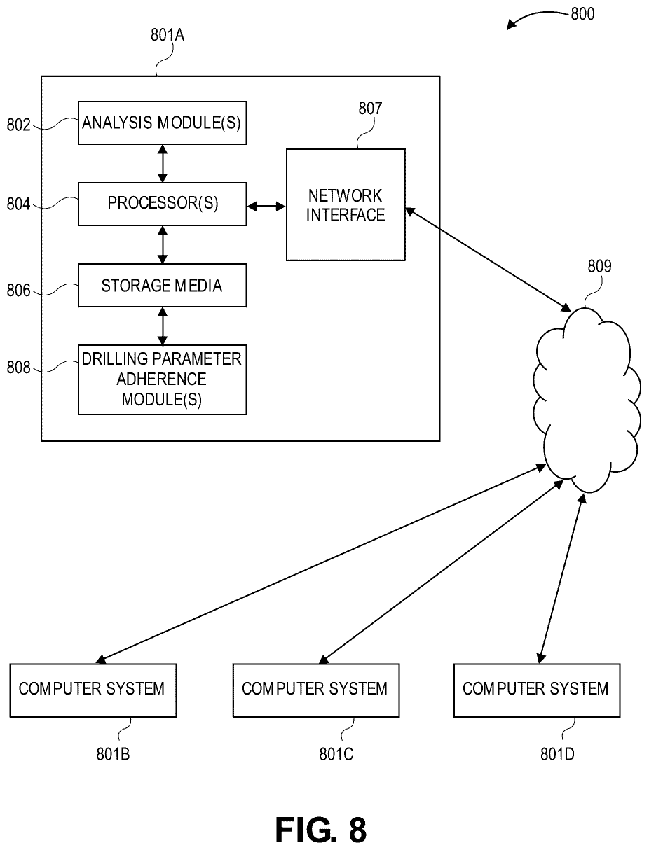

In some embodiments, the methods of the present disclosure may be executed by a computing system. FIG. 8 illustrates an example of such a computing system 800, in accordance with some embodiments. The computing system 800 may include a computer or computer system 801A, which may be an individual computer system 801A or an arrangement of distributed computer systems. The computer system 801A includes one or more analysis modules 802 that are configured to perform various tasks according to some embodiments, such as one or more methods disclosed herein. To perform these various tasks, the analysis module 802 executes independently, or in coordination with, one or more processors 804, which is (or are) connected to one or more storage media 806. The processor(s) 804 is (or are) also connected to a network interface 807 to allow the computer system 801A to communicate over a data network 809 with one or more additional computer systems and/or computing systems, such as 801B, 801C, and/or 801D (note that computer systems 801B, 801C and/or 801D may or may not share the same architecture as computer system 801A, and may be located in different physical locations, e.g., computer systems 801A and 801B may be located in a processing facility, while in communication with one or more computer systems such as 801C and/or 801D that are located in one or more data centers, and/or located in varying countries on different continents).

A processor may include a microprocessor, microcontroller, processor module or subsystem, programmable integrated circuit, programmable gate array, or another control or computing device.

The storage media 806 may be implemented as one or more computer-readable or machine-readable storage media. Note that while in the example embodiment of FIG. 8 storage media 806 is depicted as within computer system 801A, in some embodiments, storage media 806 may be distributed within and/or across multiple internal and/or external enclosures of computing system 801A and/or additional computing systems. Storage media 806 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 800 contains one or more drilling parameter adherence module(s) 808. It should be appreciated that computing system 800 is merely one example of a computing system, and that computing system 800 may have more or fewer components than shown, may combine additional components not depicted in the example embodiment of FIG. 8, and/or computing system 800 may have a different configuration or arrangement of the components depicted in FIG. 8. The various components shown in FIG. 8 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 800, FIG. 8), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for monitoring an adherence of actual drilling parameters to planned drilling parameters in real-time, the method comprising:
receiving a well plan for a well, wherein the well plan comprises a plurality of planned drilling parameters corresponding to a plurality of intervals in the well;
receiving actual drilling parameters corresponding to the plurality of intervals in the well;
comparing the actual drilling parameters to the planned drilling parameters;
determining a plurality of compliance indicators based at least partially upon the comparison, wherein the compliance indicators indicate a level of adherence between the actual drilling parameters adhere to the planned drilling parameters; and
generating a first alarm in response to greater than a first predetermined amount and less than a second predetermined amount of the compliance indicators being below a planned minimum threshold, above a planned maximum threshold, or both.

2. The method of claim 1, wherein the intervals comprise depth intervals or time intervals.

3. The method of claim 1, wherein the planned drilling parameters each comprise a minimum value, a maximum value, and a recommended value.

4. The method of claim 1, wherein the planned drilling parameters comprise a planned depth of the well, a planned rate of rotation of a tubular string in the well, a planned weight on a drill bit in the well, a planned flow rate of a fluid into or out of the well, a planned rate of penetration in the well, or a combination thereof, and wherein the actual drilling parameters comprise a measured depth of the well, a measured rate of rotation of the tubular string in the well, a measured weight on the drill bit in the well, a measured flow rate of the fluid into or out of the well, a measured rate of penetration in the well, or a combination thereof.

5. The method of claim 1, wherein a first of the compliance indicators comprises a plurality of first values representing differences between a first of the actual drilling parameters and a first of the planned drilling parameters at each of the intervals in the well.

6. The method of claim 1, further comprising generating a second alarm in response to greater than the second predetermined amount of the compliance indicators being below the planned minimum threshold, above the planned maximum threshold, or both, wherein the second predetermined amount is greater than the first predetermined amount.

7. The method of claim 6, wherein the second alarm is also or instead generated in response to greater than the first predetermined amount and less than the second predetermined amount of the compliance indicators being below the planned minimum threshold, and greater than the first predetermined amount and less than the second predetermined amount of the compliance indicators being above the planned maximum threshold.

8. The method of claim 1, generating a display based upon the comparison, the compliance indicators, the first alarm, or a combination thereof.

9. The method of claim 1, further comprising performing a wellsite action in response to the comparison, the compliance indicators, the first alarm, or a combination thereof.

10. The method of claim 9, wherein the wellsite action comprises varying a depth of the well, varying a rate of rotation of a tubular string in the well, varying a weight on a drill bit in the well, varying a flow rate of a fluid into or out of the well, varying a rate of penetration in the well, or a combination thereof.

11. A computing system comprising:
one or more processors; and
a memory system comprising one or more non-transitory computer-readable media storing instructions that, when executed by at least one of the one or more processors, cause the computing system to perform operations, the operations comprising:
receiving a well plan for a well, wherein the well plan comprises a plurality of planned drilling parameters corresponding to a plurality of intervals in the well, wherein the intervals comprise depth intervals or time intervals, wherein the planned drilling parameters each comprise a minimum value, a maximum value, and a recommended value, and wherein the planned drilling parameters comprise a planned depth of the well, a planned rate of rotation of a tubular string in the well, a planned weight on a drill bit in the well, a planned flow rate of a fluid into or out of the well, a planned rate of penetration in the well, or a combination thereof;
receiving actual drilling parameters corresponding to the plurality of intervals in the well, wherein the actual drilling parameters comprise a measured depth of the well, a measured rate of rotation of the tubular string in the well, a measured weight on the drill bit in the well, a measured flow rate of the fluid into or out of the well, a measured rate of penetration in the well, or a combination thereof;
comparing the actual drilling parameters to the planned drilling parameters;
determining a plurality of compliance indicators based at least partially upon the comparison, wherein the compliance indicators indicate a level of adherence between the actual drilling parameters adhere to the planned drilling parameters, wherein a first of the compliance indicators comprises a plurality of first values representing differences between a first of the actual drilling parameters and a first of the planned drilling parameters at each of the intervals in the well, and wherein a second of the compliance indicators comprises a plurality of second values representing differences between a second of the actual drilling parameters and a second of the planned drilling parameters at each of the intervals in the well;
generating a first alarm in response to greater than a first predetermined amount and less than a second predetermined amount of the first values being below a planned minimum threshold, above a planned maximum threshold, or both;
generating a second alarm in response to greater than the second predetermined amount of the first values being below the planned minimum threshold, above the planned maximum threshold, or both;
generating a third alarm in response to greater than the first predetermined amount and less than the second predetermined amount of the first values being below the planned minimum threshold, and greater than the first predetermined amount and less than the second predetermined amount of the first values being above the planned maximum threshold; and
generating a display based upon the comparison, the compliance indicators, the first alarm, the second alarm, the third alarm, or a combination thereof.

12. The computing system of claim 11, wherein the operations further comprise determining a statistical distribution of the actual drilling parameters, wherein the statistical distribution is based at least partially upon the well plan, wherein the statistical distribution is determined by percentiles and summarized at each of the intervals, and wherein the comparison includes comparing the statistical distribution of the actual drilling parameters to the planned drilling parameters.

13. The computing system of claim 11, wherein the plurality of compliance indicators further comprises an aggregate compliance indicator based upon the first and second compliance indicators.

14. The computing system of claim 11, wherein the planned minimum threshold is different at two or more of the intervals, and wherein the planned maximum is different at two or more of the intervals.

15. The computing system of claim 11, wherein the operations further comprise generating or transmitting a signal in response to the comparison, the compliance indicators, the first alarm, the second alarm, the third alarm or a combination thereof.

16. A non-transitory computer-readable medium storing instructions that, when executed by at least one processor of a computing system, cause the computing system to perform operations, the operations comprising:
receiving a well plan for a well, wherein the well plan comprises a plurality of planned drilling parameters corresponding to a plurality of intervals in the well, wherein the intervals comprise depth intervals or time intervals, wherein the planned drilling parameters each comprise a minimum value, a maximum value, and a recommended value, and wherein the planned drilling parameters comprise a planned depth of the well, a planned rate of rotation of a tubular string in the well, a planned weight on a drill bit in the well, a planned flow rate of a fluid into or out of the well, and a planned rate of penetration in the well;
receiving actual drilling parameters corresponding to the plurality of intervals in the well, wherein the actual drilling parameters are received substantially in real-time, wherein the actual drilling parameters comprise a measured depth of the well, a measured rate of rotation of the tubular string in the well, a measured weight on the drill bit in the well, a measured flow rate of the fluid into or out of the well, and a measured rate of penetration in the well;
determining a statistical distribution of the actual drilling parameters, wherein the statistical distribution is based at least partially upon the well plan, and wherein the statistical distribution is determined by percentiles and summarized at each of the intervals;
comparing the actual drilling parameters to the planned drilling parameters, wherein the comparison includes comparing the statistical distribution of the actual drilling parameters to the planned drilling parameters;
determining a plurality of compliance indicators based at least partially upon the comparison, wherein the compliance indicators indicate a level of adherence between the actual drilling parameters adhere to the planned drilling parameters, wherein a first of the compliance indicators comprises a plurality of first values representing differences between a first of the actual drilling parameters and a first of the planned drilling parameters at each of the intervals in the well, and wherein a second of the compliance indicators comprises a plurality of second values representing differences between a second of the actual drilling parameters and a second of the planned drilling parameters at each of the intervals in the well, and wherein the plurality of compliance indicators further comprises an aggregate compliance indicator based upon the first and second compliance indicators;
generating a first alarm in response to greater than a first predetermined amount and less than a second predetermined amount of the first values and the second values being below a planned minimum threshold, above a planned maximum threshold, or both, wherein the planned minimum threshold is different at two or more of the intervals, and wherein the planned maximum is different at two or more of the intervals;
generating a second alarm in response to greater than the second predetermined amount of the first values and the second values being below the planned minimum threshold, above the planned maximum threshold, or both;
generating a third alarm in response to greater than the first predetermined amount and less than the second predetermined amount of the first values and the second values being below the planned minimum threshold, and greater than the first predetermined amount and less than the second predetermined amount of the first values and the second values being above the planned maximum threshold;
generating a display based upon the comparison, the compliance indicators, the first alarm, the second alarm, the third alarm, or a combination thereof; and
generating or transmitting a signal in response to the comparison, the compliance indicators, the first alarm, the second alarm, the third alarm or a combination thereof.

17. The non-transitory computer-readable medium of claim 16, wherein the display comprises one or more graphs showing the planned drilling parameters versus the actual drilling parameters at each of the intervals in the well.

18. The non-transitory computer-readable medium of claim 17, wherein the display also comprises one or more graphs showing the compliance indicators versus the planned minimum threshold and the planned maximum threshold at each of the intervals in the well.

19. The non-transitory computer-readable medium of claim 16, wherein the signal causes a physical action to occur at a wellsite where the well is located.

20. The non-transitory computer-readable medium of claim 19, wherein the physical action comprises varying the depth of the well, varying the rate of rotation of the tubular string in the well, varying the weight on the drill bit in the well, varying the flow rate of the fluid into or out of the well, varying the rate of penetration in the well, or a combination thereof.
